(19) United States
(12) Patent Application Publication
(10) Pub. No.: US 2025/0079105 A1
(43) Pub. Date: Mar. 6, 2025

(54) FUSE HOLDER

(71) Applicant: Weidmüller Interface GmbH & Co. KG, Detmold (DE)

(72) Inventors: Henrik BUCHE, Lemgo (DE); Mario TRAPE, New South Wales (AU)

(21) Appl. No.: 18/294,007

(22) PCT Filed: Aug. 19, 2022
(86) PCT No.: PCT/EP2022/073229

§ 371 Date: Jan. 31, 2024

(30) Foreign Application Priority Data
Sep. 6, 2021 (DE) 10 2021 123 029.2

(51) Int. Cl. H01H 85/20; H01H 85/12; H01H 85/22; H01H 85/38

(52) U.S. Cl. CPC H01H 85/202; H01H 85/12; H01H 85/22; H01H 85/38

(57) ABSTRACT

A fuse holder for an in-line fuse, including a multipart housing, a fuse carrier for a fuse and at least one closure element, characterized in that the housing has at least a first housing part with an interior space and at least a second housing part with an interior space, the housing parts can be moved from a closed position, in which the housing parts are connected to one another by the closure element and enclose the interior spaces, into an open position, in which the housing parts are spaced apart from one another by an opening width and the interior spaces are open, and back in the direction of a longitudinal axis of the fuse holder.

### BACKGROUND

The present invention relates to a fuse holder, and more particularly a fuse holder for an in-line fuse.

Fuse holders for in-line fuses are known in multiple variants. The fuse holders are built in-line, wherein an input wire and an output wire are electrically conductively connected to terminals in the fuse holder. The terminals are in electrically conductive connection, e.g. via terminal contacts, with a fuse inside a housing of the fuse holder. The fuse consists of a wire that is installed in a tubular body, often also with extinguishing mediums. Depending on the application, the tubular body is made of glass, plastic or ceramic. Depending on the operating voltage and current, the fuses in the body are protected against contact during check and change. At high voltages, there is a risk of arcing between live parts such as the fuse and a user. This can be the case, for example, at photovoltaic systems.

Some fuse holders are provided with devices into which the fuse is first inserted initially and then inserted or pushed into its clamping position by a movable part of this device.

Examples of fuse holders are described in the following documents:

U.S. Pat. No. 4,909,761 B describes a holder for an electric fuse having a first receiving body which has an internally threaded nut assembled thereto in a manner allowing relative rotation between them. The assembly of the nut to the body allows separation of the nut from the body when a predetermined axial separating force is imparted between the parts, without damage to them. A second fuse receiving body has an external thread, which engages the thread of the first body. As the threaded connection is made the body sections are drawn together to enclose the fuse therein.

WO 2016/094 488 A1 relates to a fuse assembly including a housing comprising a first compartment and a second compartment. The fuse assembly also includes a fuse holder movable between a closed position and an open position relative to the housing. A fuse can be removed when the fuse holder is in the open position, and the fuse is inaccessible when the fuse holder is in the closed position. The fuse assembly also includes a first connector comprising a first fuse contact disposed at one end and a first wire coupler disposed at an opposite end. The first connector is slidable between an engaged position and a disengaged position within the first compartment. The connector is electrically coupled to the fuse in the engaged position and electrically decoupled in the disengaged position. The first connector locks the fuse holder in the closed position when the first connector is in the engaged position.

The known solutions have proven themselves. However, there is a constant need for further development, whereby greater functionality is created with increased safety, compact construction and a smaller number of components.

### SUMMARY OF THE INVENTION

It is an object of the present disclosure to provide a fuse holder for an in-line fuse, which includes a multi-part housing, a fuse carrier for a fuse and at least one closure element. The housing has at least one first housing part with an interior space and at least one second housing part with an interior space, the housing parts can be moved from a closed position, in which the housing parts are connected to one another by the closure element and enclose the interior spaces, into an open position, in which the housing parts are spaced apart from one another by an opening width and the interior spaces are open, and back in the direction of a longitudinal axis of the fuse holder.

A particular advantage results from a simple structure, easy handling and high safety.

In one embodiment, in the closed position of the housing parts, the fuse carrier is accommodated within the interior spaces of the housing parts concentrically to a longitudinal axis of the fuse holder, and in the open position of the housing parts, the fuse carrier is arranged within the opening width between the mutually spaced housing parts concentrically to the longitudinal axis of the fuse holder. This is advantageous because, on the one hand, the fuse carrier is completely enclosed in the housing in the closed position and is protected against contact. On the other hand, in the open position, the fuse carrier is accessible from all sides for insertion and removal of the fuse without the possibility of contact with live parts.

In a further embodiment, the fuse carrier is formed as a tubular body with two fuse carrier sections and is rotatable about the longitudinal axis of the fuse holder from the closed position of the housing parts from an exit angle to the open position of the housing parts to an end angle and back again about the longitudinal axis of the fuse holder by a rotation angle. It is advantageous that the fuse holder is tubular, since it is thus easily accommodated in the housing and forms a space-saving receptacle for the fuse.

In another embodiment, the angle of rotation of the fuse carrier between the starting angle and the end angle about the longitudinal axis of the fuse holder is 180°. In this way, the insertion of a fuse located in the fuse carrier is facilitated by twisting it into the terminal contacts. Furthermore, in the open position, the fuse is rotated into a predetermined position with the fuse carrier, in which easy insertion and removal of the fuse into and from the fuse carrier is made possible.

It is advantageous if the fuse carrier has a motion screw thread as an external thread, which engages with a motion screw thread as an internal thread of the internal spaces, since in this way a displacement movement of the housing parts automatically causes a rotation of the fuse carrier and the fuse carrier does not have to be touched. All that needs to be done is to pull the housing parts apart/push them together. The user's hands are on the insulated housing and not on the fuse carrier.

With the rotation of the fuse carrier in a load break condition, the rotational motion will reduce the arc intensity, therefore the ARC would not only be extinguished because of a clearance between the contacts and the fuse, but also due to the rotational motion of the fuse.

In a further embodiment, the internal thread of the interior of the first housing part together with the external thread of the first fuse carrier section of the fuse carrier in engagement therewith and the internal thread of the interior of the second housing part together with the external thread of the second fuse carrier section of the fuse carrier in engagement therewith are formed in opposite directions to one another. Such a design of the two counter-rotating motion screw threads in right-hand thread and left-hand thread has the advantage that when the housing parts are pulled apart/slid together, the rotating fuse carrier always remains in the centre between the housing parts and the contact ends of the fuse are released and removed from the terminals at the same speed.

In another embodiment, the fuse carrier has clip-shaped holding sections in its interior, which hold an associated fuse in a central area in the interior of the fuse carrier. This facilitates insertion and removal of the fuse and enables the fuse to be held firmly in the fuse carrier.

In a still further embodiment, the fuse carrier has end sections at its ends, each of which forms a free space as an arc chamber when the fuse holder is in the open position. In a preferred embodiment, one length of this arcing chamber is twice as long as the air gap in accordance with single-leg regulations. This means that an arc between the terminals and the fuse contacts is extinguished halfway before the fuse can be touched in the open position. In addition, having a rotational fuse carrier assists on the arc extinguishing. With the rotation of the fuse carrier in a load break condition, the rotational motion will reduce the arc intensity, therefore the ARC would not only be extinguished because of the clearance between the contacts and the fuse, but also due to the rotational motion of the fuse. This not only prevents contact with live parts, but also increases safety against arcing to the user.

The fuse carrier as well as the fuse carrier sections are considered as sacrificial parts during an arc, so the plastic encapsulates the fuse terminals, avoiding the external surface of the fuse holder of the inline fuse to deform, potentially burning the operator.

The housing parts, the closure element as well as the fuse carrier are made of an electrically non-conductive material whose properties, such as contact safety, temperature, flammability (e.g. UL94V0), etc., comply with the applicable safety regulations with regard to the operating parameters and intended use of the fuse.

It is advantageous if the fuse carrier has two radially opposite window cut-outs in its central area, the dimensions of one window cut-out corresponding to a length and diameter of a fuse to be accommodated in the fuse carrier. This makes it advantageously easier to push the fuse out of its position from the clip holders of the fuse carrier through the small window and through the large window without tools.

In a further embodiment, it is provided that the housing parts are coupled to at least one guide rail arranged parallel to the longitudinal axis of the fuse holder. The guide rails advantageously facilitate a movement of the housing parts.

For this purpose, it is advantageous that the at least one guide rail is accommodated and guided in guide recesses corresponding to the shape of the at least one guide rail in each housing part so as to be movable in the direction of the longitudinal axis of the fuse holder.

In a further embodiment, a further advantage results if the at least one guide rail limits a stop for axial movement of the housing parts in the open position. In this way, the housing parts and the fuse carrier are held captive.

In a further embodiment, the fuse holder has connection terminals for electrical lines, the connection terminal being designed with a contact device for a fuse to be accommodated in the fuse carrier. This is advantageous for easy connection.

It is also particularly advantageous if the contact device has a spring within the contact device which applies a constant contact force to the fuse contacts, or/and that the contact device has circumferentially resilient lamella contacts or lamella springs, which form an electrically conductive connection receptacle for a fuse contact of the fuse, since in this way effective contacting of the fuse contacts can be enabled.

Another embodiment provides that a fuse holder includes at least two of the above-described fuse holders, wherein the first housing parts of the at least two fuse holders comprise housing sections which are connected at their free ends by a connection. In this way, a connection of two and more fused input lines to a common output line with simultaneous fusing of the individual input lines is easily possible. Such a fuse holder can be formed e.g. in Y-shape, in T-shape or the like.

Examples of embodiments of the invention are described below with reference to the accompanying drawings. These examples of embodiments serve merely to illustrate the invention by means of preferred constructions which, however, do not represent the invention conclusively. In this respect, other embodiments as well as modifications and equivalents of the embodiments shown are also realizable within the scope of the claims.

### BRIEF DESCRIPTION OF THE DRAWINGS

Other objects and advantages of the disclosure will become apparent from a study of the following specification when viewed in the light of the accompanying drawing, in which:

FIG. 1 is a schematic perspective view of a first embodiment of a fuse holder according to the invention in a closed position;

FIG. 2 is a schematic longitudinal sectional view of the first embodiment according to FIG. 1;

FIG. 3-5 are schematic views of the fuse holder according to FIG. 1 in an open position;

FIG. 6 is a schematic sectional view of the fuse holder in the open position according to FIG. 3-5;

FIG. 7 is a schematic radial sectional view of the fuse holder along line VII according to FIG. 2;

FIG. 8-9 are schematic perspective views of a second embodiment of the fuse holder according to the invention; and

FIG. 10 is a schematic radial sectional view of the second embodiment of the fuse holder along line X according to FIG. 8.

### DETAILED DESCRIPTION

The terms “top”, “bottom”, “left”, “right” refer to the respective arrangement of the components in the figures.

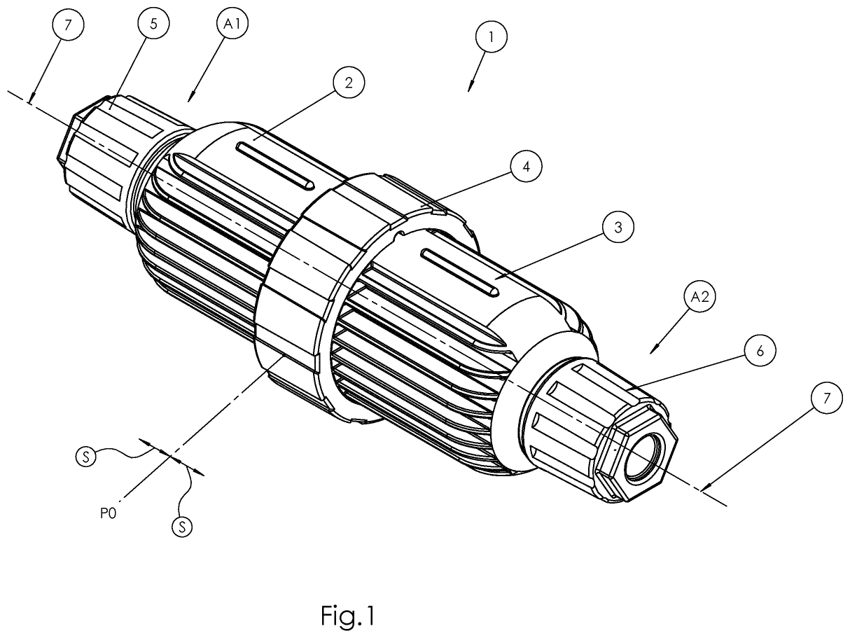

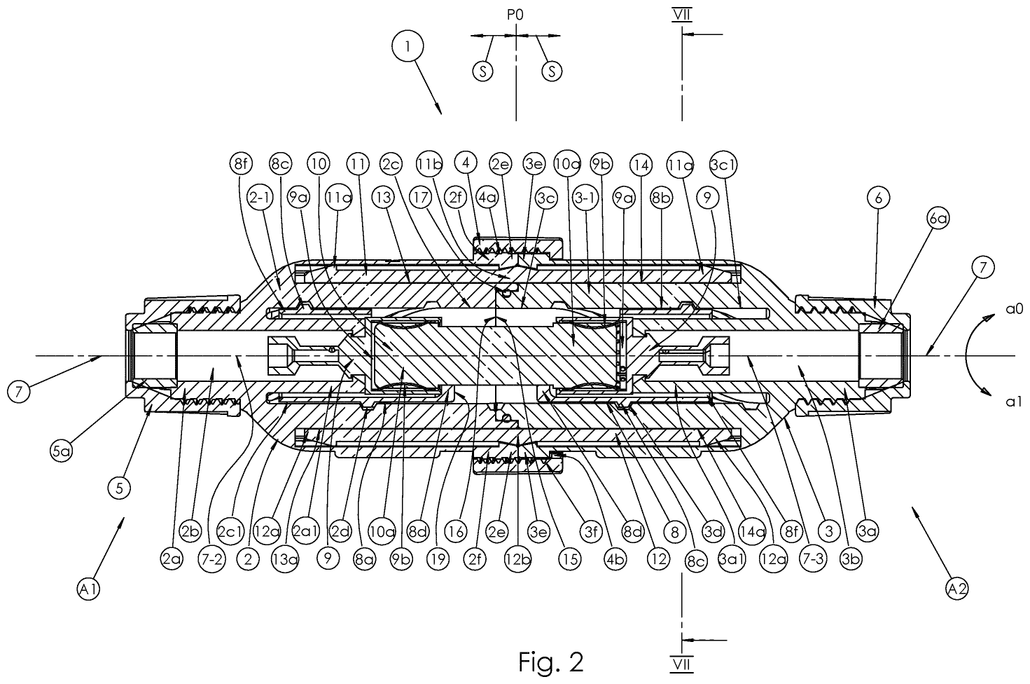

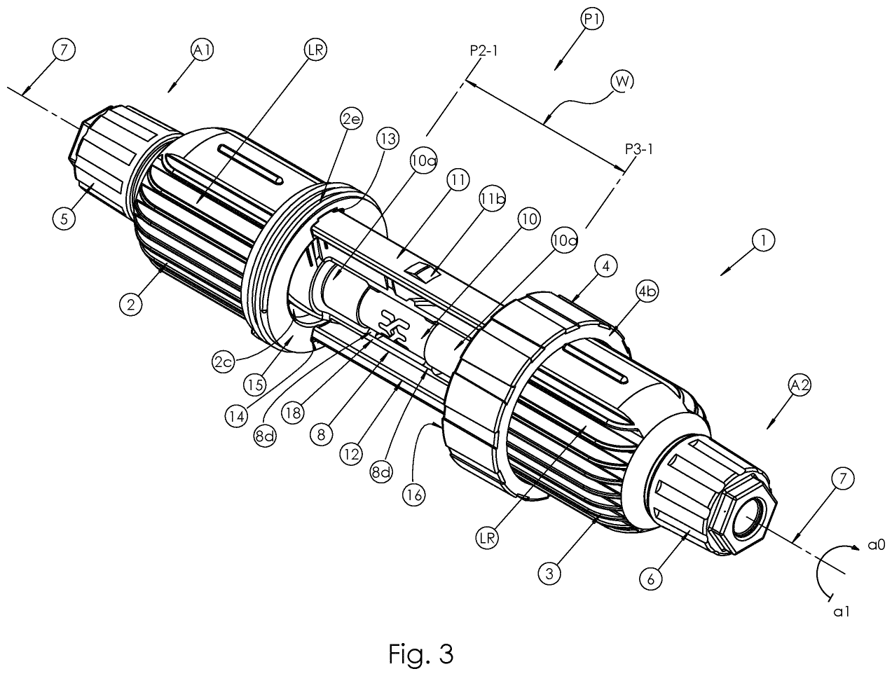

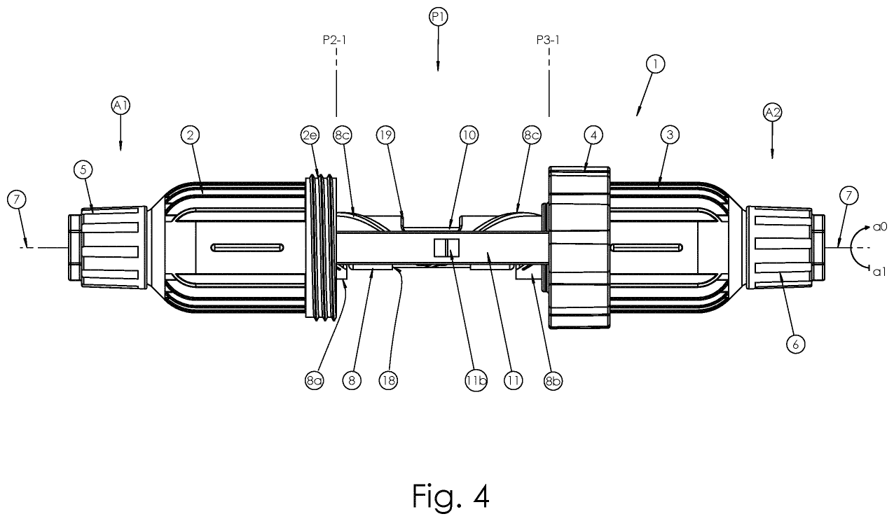

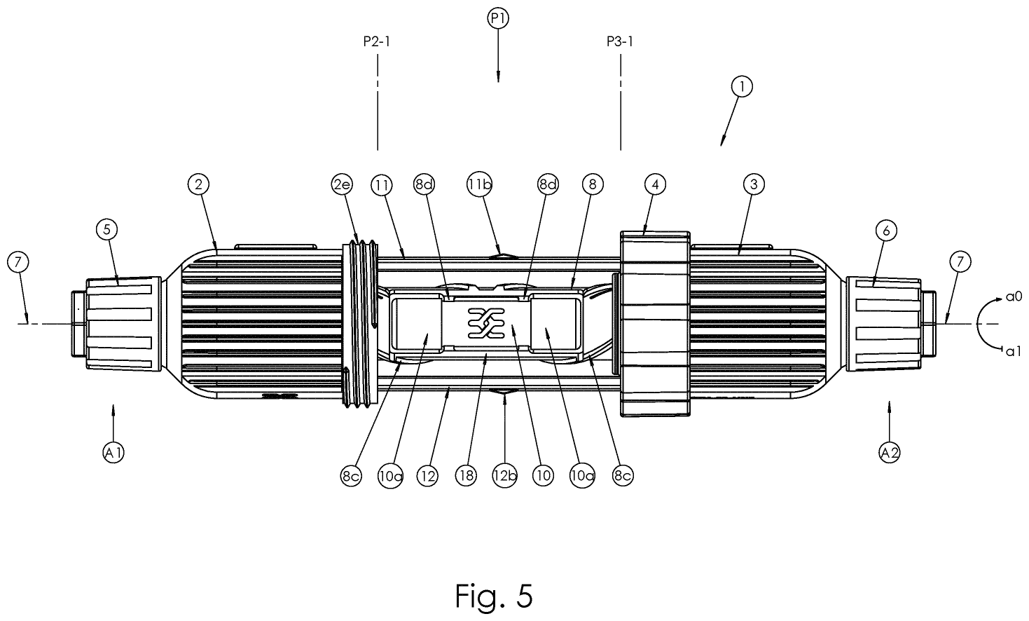

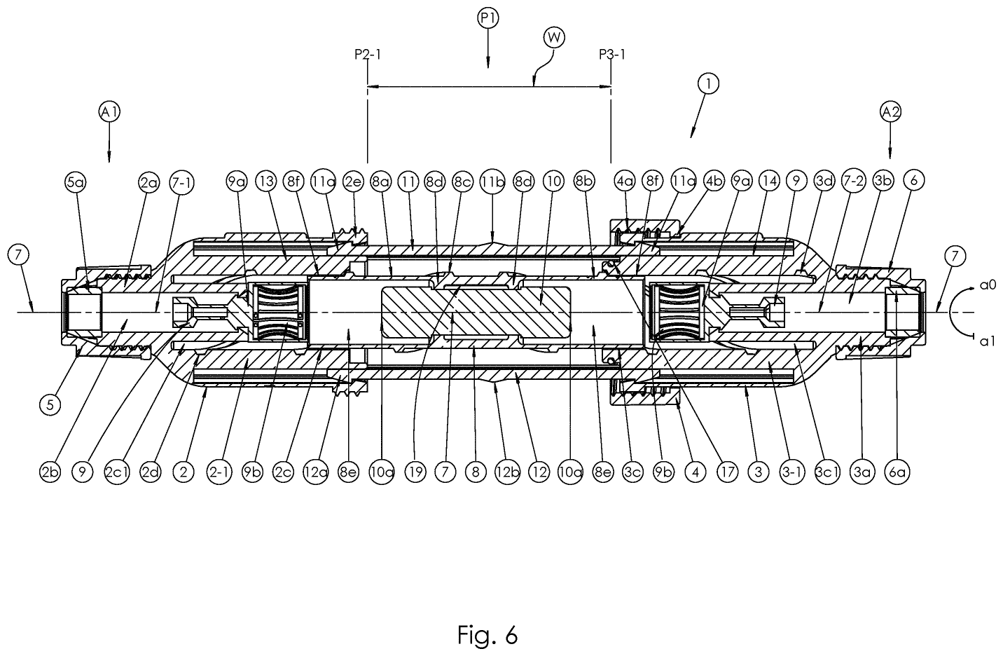

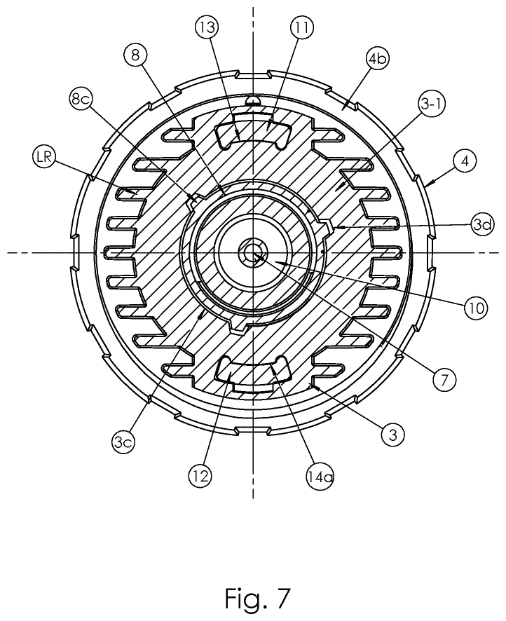

FIG. 1 shows a schematic perspective view of a first embodiment of a fuse holder 1 according to the invention in a closed position P0. FIG. 2 shows a schematic longitudinal sectional view of the first embodiment according to FIG. 1. FIGS. 3 to 5 show schematic views of the fuse holder 1 according to FIG. 1 in an open position P1. A schematic sectional view of the fuse holder 1 in the open position P1 according to FIG. 3-5 is shown in FIG. 6. FIG. 7 shows a schematic radial sectional view of the fuse holder 1 along line VII as shown in FIG. 2.

The fuse holder 1 is provided as a so-called in-line fuse holder for at least one fuse 10. The fuse 10 is e.g. a fusible link in a ceramic body with extinguishing agent. Exemplary dimensions may be, but are not limited to, 10×38 (mm) to 22×65 (mm). A preferred application are photovoltaic systems. However, other applications are of course also possible.

The fuse holder 1 has a housing which encloses a first housing part 2, a second housing part 3 and a closure element 4, in this case a union nut.

Each housing part 2, 3, has its own longitudinal axis 7-2, 7-3. The longitudinal axes 7-2, 7-3 together form a common longitudinal axis 7 of the fuse holder 1. The housing parts 2, 3 are described in further detail below.

Within the housing parts 2 and 3, the fuse 10 is arranged in a fuse carrier 8. The fuse carrier 8 is explained in more detail below.

In the closed position P0, the fuse 1 is completely enclosed by the housing parts 2, 3 and thus electrically insulated. At the same time, IP65/68 protection can be achieved in the closed position P0.

The housing parts 2, 3, the closure element 4 as well as the fuse carrier 8 are made of an electrically non-conductive material whose properties, such as contact safety, temperature, flammability (e.g. UL94V0), etc., comply with the applicable safety regulations with regard to the operating parameters and intended use of the fuse 10.

Free ends of housing parts 2 and 3 each form a connection side A1, A1. The other ends of the housing parts 2 and 3 are each provided with an end face 15, 16. In the closed position P0 of the fuse holder 1, the end faces 15, 16 are in contact with each other. They and thus the housing part 2, 3 are held firmly together by the locking element 4.

For replacement and/or removal and/or use of the fuse 10, the housing parts 2 and 3 can be pulled apart in opposite displacement directions S in the direction of the longitudinal axis 7 of the fuse holder 10 after the locking element 4 has been released. In the open position P1 of the fuse holder 1 formed in this way (FIG. 3-6), the housing parts 2, 3 are spaced apart in such a way that their end faces 15, 16 form an opening width W between open positions P2-1, P3-1 of the housing parts 2, 3. The fuse 10 can be removed from or arranged in the fuse holder 1 through the opening width W formed in this way.

In the open position P1 of the fuse holder 1 there is a protection class IP2xx.

Housing parts 2 and 3 are identical except for minor differences. The following description of the first housing part 2 therefore also applies to the second housing part 3. The reference signs belonging to the second housing part 3 are therefore indicated.

The connection side A1, A2 of the housing parts 2, 3 is formed with a tubular connection section 2a, 3a, on which an external thread for a cable gland 5, 6 is formed here at its free end. Such a cable gland 5, 6 with an elastic cable bushing 5a, 6a is known and will not be described further. It can, of course, also be designed differently.

The connection sides A1, A2 can each be equipped with an input line or output line.

The tubular connection section 2a, 3a merges into a tubular section 2a-1, 3a-1 of approximately equal length, which extends into the housing parts 2, 3 along the longitudinal axis 7-2, 7-3 of the housing parts 2, 3.

A continuous circular-cylindrical cable chamber 2b, 3b extending in the longitudinal axis 7-2, 7-3 is formed here in the tubular connection section 2a, 3a and the adjoining tubular section 2a-1, 3a-1.

The end of the tube section 2a-1, 3a-1 arranged in the housing parts 2, 3 forms in each case a holder for a terminal connector 9, which is not described in more detail. This holder can be designed for different types of connection connectors 9. In the example shown, the terminal connector 9 has a section for a crimp connection with an electrically conductive cable not shown, which is arranged in the cable space 2b, 3b. The section for the crimp connection is located in the cable space 2b, 3b. Furthermore, this section of the terminal connector 9 is formed with a contact device for a fuse 10 to be accommodated in the fuse carrier 8. In the example shown here, the contact device has a contact carrier 9a to which circumferentially resilient lamellar contacts 9b or lamellar springs are attached, which form an electrically conductive connection receptacle for a fuse contact 10a of the fuse 10.

Alternatively, the contact device has a spring within the contact device which maintains a constant contact against the fuse contacts 10a.

The tube section 2a1, 3al inside the housing parts 2, 3 is further surrounded by a housing body 2-1, 3-1 of the housing parts 2, 3. The housing body 2-1, 3-1 is fixedly connected to or integrally formed with the tubular connecting portion 2a, 3a and the tubular portion 2a-1, 3a-1 in a region of the connection thereof.

The housing body 2-1, 3a-1 has a central circular cylindrical inner space 2c, 3c. The tube section 2a-1, 3a-1 is arranged in the interior space 2c, 3c approximately in the first half of the interior space 2c, 3c starting from the connection of the housing body 2-1, 3-1 with the tube section 2a-1, 3a-1. The other half of the inner space 2c, 3c, which faces and opens into the end face 15, 16, is used to accommodate one half of a fuse carrier 8 with one half of the fuse 10 and the lamellar contacts 9b.

The fuse carrier 8 is a tubular body with two fuse carrier sections 8a and 8b. The fuse carrier sections 8a and 8b divide the fuse carrier into two halves of equal length and size. The first fuse carrier section 8a is intended for use in the first housing part 2 and has an external thread 8c in the form of a right-hand thread. The second fuse carrier section 8b is intended for use in the second housing part 3 and has an external thread 8′c in the form of a left-hand thread. The external threads 8c, 8′c are designed as movement threads.

In addition, the fuse carrier sections 8a, 8b each have an end section 8f, which is explained in further detail below.

The fuse 10 is held in a central region in the interior of the fuse carrier 8 by clip-shaped holding sections 8d.

The fuse carrier 8 also has two radially opposing window cut-outs 18, 19 in its central region, which can best be seen in FIGS. 3 to 5. A first window cut-out 18 extends in the longitudinal direction of the fuse carrier 8 and is slightly longer than the entire length of the fuse 10. A radial width of the first window cut-out 18 is slightly larger than the diameter of the fuse 10. Through this first window cut-out 18, the fuse 10 can be radially removed from the retaining sections 8d from the fuse carrier 8 or clipped into the retaining sections 8d of the fuse carrier 8. The second window cut-out 19 opposite the first window cut-out 18 is about half as long as the first window 18 and is used to push the fuse 10 out of the retaining sections 8d through the first window 18 by a finger or a tool.

The retaining sections 8d are arranged laterally as a boundary of the second window 19 at its radial edges.

In the area of the tube section 2a-1, 3a-1, a circular annular gap 2c1, 3cl is formed between its circumferential circular cylindrical outer wall, the diameter of which corresponds to the diameter of the inner space 2c, 3c.

In the wall of the inner space 2c, 3c including the annular gap 2c1, 3cl, an internal thread 2d, 3d is formed as a movement thread in each case. However, the internal threads 2d, 3d are formed in opposite directions to each other, i.e. the internal thread 2d of the internal space 2c of the first housing part 2 is a right-hand thread, and the internal thread 3d of the internal space 3c of the second housing part 3 is a left-hand thread.

The first, right-handed internal thread 2d corresponds to the right-handed external thread 8c of the first fuse carrier section 8a of the fuse carrier 8, and the second, left-handed internal thread 3d corresponds to the left-handed external thread 8′c of the second fuse carrier section 8b of the fuse carrier 8.

The fuse carrier 8 is screwed into the inner space 2c, 3c including the annular gap 2cl, 3cl, its external threads 8c, 8′c engaging with the internal threads 2d, 3d of the housing parts 2, 3. In the position P0, the end sections 8f of the fuse carrier 8 engage around the respective tube sections 2al and 3a1.

The housing parts 2, 3 with their connection sections 2a, 3a and tube sections 2a1, 3al, the inner spaces 2c, 3 with the annular gaps 2c1, 3cl and the fuse carrier 8 are arranged concentrically to the longitudinal axis 7 of the fuse holder 1.

Furthermore, the fuse holder 1 has at least one axial guide rail 11, 12.

In the first embodiment shown, two guide rails 11, 12 are provided. Each guide rail 11, 12 has two respective nose-shaped rail ends 11a, 12a and a respective central nose 11b, 12b.

Each guide rail 11, 12 has a flat, circular ring-shaped profile with downwardly projecting, extended side edges in the longitudinal direction of the respective guide rail 11, 12 (FIG. 7).

For each guide rail 11, 12, a guide recess 13, 14; 13a, 14a corresponding to its shape is formed in a respective outer region of each housing part 2, 3. The guide recesses 13, 14; 13a, 14a run parallel to the longitudinal axes 7-2, 7-3 of the housing parts 2, 3 and extend over almost the entire length of the housing parts 2, 3.

Each opening of each guide recess 13, 14; 13a, 14a is provided with a lug 2e, 3e which protrudes towards the underside of the associated opening.

In the closed position P0 of the fuse holder 1, the guide rails 11 and 12 are each inserted with one half into the guide recesses 13 and 13a of the first housing part 2 and with their other half into the guide recesses 14 and 14a of the second housing part 3. This can be clearly seen in FIG. 2.

The locking element 4 is used to maintain the closed position P0. The locking element 4 is provided here as a union nut with an internal thread 4a that faces the first housing part 2. On the side of the closure element 4 facing the second housing part 3, the internal thread 4a is terminated by a shoulder 4b.

The closure element 4 is screwed from the second housing part 3 onto an external thread of a collar 2f of the first housing part 2. The circumferential collar 2f with the external thread is attached to the end of the first housing part 2 with the end face 15. During screwing, the housing parts 2, 3 are drawn together in the displacement direction S, with the shoulder 4b of the closure element 4 interacting with a collar 3f of the second housing part 3 and the end faces 15, 16 of the housing parts 2, 3 coming into contact with each other.

Furthermore, in the closed position P0 of the fuse holder 1, slopes of the lugs 2e, 3e of the housing parts 2, 3 are in contact with slopes of the central lugs 11b, 12b of the guide rails 11, 12 and thus improve the closure of the inner spaces 2c, 3c of the housing parts 2, 3. A sealing of the inner spaces 2c, 3c is furthermore achieved here by a sealing element 17. The sealing element is, for example, an O-ring, which is fitted between the end faces 15, 16. In the example shown in FIG. 2, the O-ring is arranged on a connecting piece of the first housing part 3, this connecting piece being positively received in a recess of the second housing part 2.

For replacement or removal or/and insertion of the fuse 10, the housing parts 2, 3 can be pulled apart in opposite displacement directions S in the direction of the longitudinal axis 7 of the fuse holder 10 after the locking element 4 has been released. In this case, the displacement movement is limited when the lugs 2e, 3e cooperate with the lug-shaped rail ends 11a, 12a of the respective guide rails 13, 14; 13a, 14a inserted into the guide recesses 13, 14; 13a, 14a as a stop to prevent the respective guide rail 13, 14; 13a, 14a from being pulled out. Thus the housing parts 2, 3 are captively connected. This is clearly illustrated in FIG. 6.

In this way, the open position P1 of the fuse holder 1 (FIG. 3-6) is taken with the opening width W between open positions P2-1, P3-1 of the housing parts 2, 3.

When the housing parts 2, 3 are pulled apart and pushed together, the fuse holder 8 together with the fuse 10 is rotated about the longitudinal axis 7 by a certain angle of rotation a and at the same time forcibly displaced. In the closed position P0, the associated angle is referred to here as the initial angle α0, and in the open position P1, an end angle α1 is assumed. In the embodiment shown, the twisting angle α between the initial angle α0 and the end angle α1 is 180°.

By twisting the fuse carrier 8, it is ensured that the fuse carrier 8 together with the fuse 10 is evenly removed from the contacts of the terminal connector 9 when it is pulled out and does not get stuck in one.

Twisting the fuse carrier 8 can facilitate insertion of the fuse 10 with its fuse contacts into the contacts of the terminal connector 9, which are designed here as lamellar contacts 9b. This also applies to pulling out.

In the open position P1, the fuse 10 with its fuse contacts 10a with the fuse carrier 8 is not only pulled out of the contacts of the terminal connectors 9, but is so far away from them that a free space 8e is formed in each case on both sides of the fuse contacts 10a to the respective contact of the terminal connector 9. In the open position P1, these free spaces 8e ensure a prescribed air gap of the fuse contacts 10a to the respective associated contact of the terminal connector 9. In the embodiment shown, the air gap formed by these clearances 8e is approximately twice the prescribed air gap.

Each clearance 8e is surrounded by an end section 8f of the fuse carrier 8. The end sections 8f here form hollow cylinders with a circular cross-section.

When the fuse holder 1 is moved from the closed position P0 to the open position P1 in operation of the fuse 10 under load (i.e. operating current flows through the fuse 10), the free spaces 8e (see FIG. 6) each serve as arcing chambers. In this way, the arcs that occur when the fuse contacts 10a of the fuse 10 are pulled out of the contacts of the terminal connectors 9 are safely extinguished in the free spaces 8e within the fuse carrier 8 due to the resulting necessary air gap. In this way, danger to the user can be minimized and eliminated.

The fuse carrier 8 as well as the fuse carrier sections 8a, 8b are considered as sacrificial parts during an arc, so the plastic encapsulates the fuse terminals, avoiding the external surface of the fuse holder of the inline fuse to deform, potentially burning the operator.

In the open position P1, the fuse carrier 8 is arranged within the opening width W between the spaced housing parts 2, 3 concentrically to the longitudinal axis 7 of the fuse holder 1. Thereby, a part of each end section 8f of the fuse carrier 8 still remains in the associated entrance section of the inner space 2c, 3c of the associated housing part 2, 3.

The housing parts 2, 3 of the fuse holder 1 may furthermore be provided with ribs LR, which serve for cooling purposes, for example. In the shown embodiment, the ribs LR run in longitudinal direction parallel to the longitudinal axis 7.

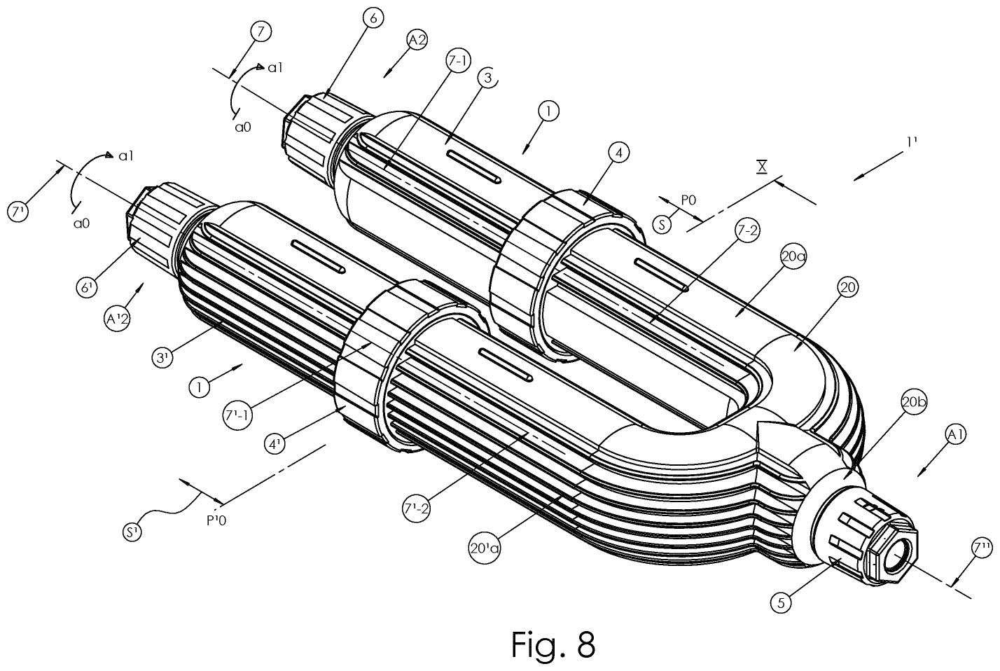

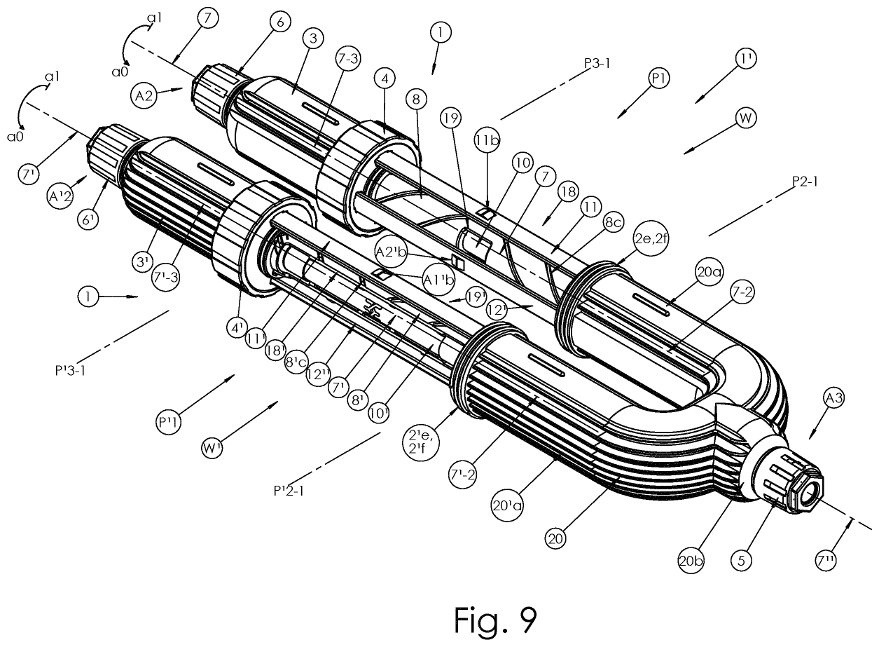

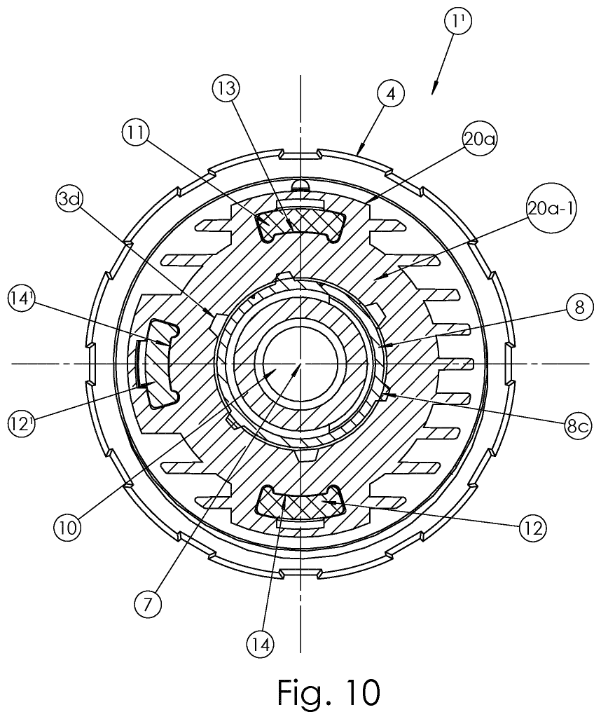

FIG. 8 shows a schematic perspective view of a second embodiment of the fuse holder 1 according to the invention in closed positions P0, P′0. FIG. 9 shows the second embodiment according to FIG. 8 in open positions P1, P′1. FIG. 10 shows a schematic radial sectional view of the second embodiment of the fuse holder along line X according to FIG. 8.

In the second embodiment, two fuse holders 1 are connected to form a common fuse holder 1′.

The first housing parts 2 of the two fuse holders 1 comprise housing sections 20a, 20′a which are connected at their free ends by a joint 20.

Thus, the fuse holder 1′ includes at least two housing sections 20a, 20′a connected by a housing connection 20 at their first ends, at least two second housing parts 3, 3′ and at least two closure elements 4, 4′.

The housing sections 20a, 20′a each corresponds to a first housing section 2 of the first embodiment but each without the connection sides A1 at their ends. These ends are connected to the housing connection 20. The housing connection 20 has a U-shape and is connected at its apex to a connection section 20b, which forms the first connection side A1 with a cable gland 5 and has a longitudinal axis 7″.

In this example, the housing parts 3 and housing sections 20a of the first fuse holder 1 are arranged parallel to the housing parts 3′ and housing sections 20′a of the second fuse holder 1. Of course, they can also be arranged at an angle to each other. In this case, the housing connection 20 does not have a U-shape, but a correspondingly adapted shape, for example a V-shape, a T-shape or a similar shape.

The other ends of the housing portions 20a, 20′a are formed in accordance with the end of the first housing portion 2 of the first embodiment with the circumferential collar 2f, 2′f having external threads for the closure elements 4, 4′.

The second housing parts 3 and the closure elements 4, 4′ slid thereon correspond to the second housing part 3 and the closure element 4 of the first embodiment.

In this way, a so-called Y-connector is formed. Two respective connection sides A2 and A′2 carry input lines which are electrically conductively connected in the fuse holder 1′ in the housing connection 20 not shown in more detail to a common output line which is led out through the first connection side A1.

The closure elements 4, 4′ can be released independently of one another, whereby the second housing parts 3, 3′ can also be displaced by the associated housing sections 20a, 20′a in the longitudinal direction 7, 7′ independently of one another from the respective closed position P0, P′0 into the open position P1, P′1. The respective opening width W, W′ is formed between the open positions P3-1, P′3-1 and P2-1, P′2-1.

The fuse carriers 8, 8′ are arranged with their movement threads 8c, 8′c in such a way that their small windows 19 face each other in the open position P1, P′1 and the large windows 18 face outwards so that a simple exchange of the respective fuse 10, 10′ can be made. Of course, the windows 18, 19 can also be arranged pointing upwards or downwards. In contrast to the first embodiment, three guide rails 11, 12, 12′ and 11′, 12′, 12″ are provided in each case here (see also FIG. 10).

This second embodiment can of course also be formed more than two individual fuse holders 1.

The invention is not limited to the described embodiments, but can be modified within the scope of the claims.

For example, it is conceivable that the locking element 4 has a latching mechanism for locking instead of the thread.

1. A fuse holder for an in-line fuse, comprising a multipart housing, a fuse carrier for a fuse and at least one closure element, wherein the housing has at least a first housing part with an interior space and at least a second housing part with an interior space, the housing parts can be moved from a closed position, in which the housing parts are connected to one another by the closure element and enclose the interior spaces, into an open position, in which the housing parts are spaced apart from one another by an opening width and the interior spaces are open, and back in the direction of a longitudinal axis of the fuse holder.

2. The fuse holder according to claim 1, wherein the fuse carrier in the closed position of the housing parts is accommodated within the inner spaces of the housing parts concentrically to a longitudinal axis of the fuse holder, and in that the fuse carrier is arranged in the open position of the housing parts within the opening width between the housing parts spaced apart from one another concentrically to the longitudinal axis of the fuse holder.

3. The fuse holder according to claim 1, wherein the fuse carrier is formed as a tubular body with two fuse carrier sections and is rotated around the longitudinal axis of the fuse holder from the closed position of the housing parts from an initial angle into the open position of the housing parts into an end angle and back again around the longitudinal axis of the fuse holder through a twisting angle.

4. The fuse holder according to claim 3, wherein a torsion angle of the fuse carrier between the initial angle and the final angle about the longitudinal axis of the fuse holder is 180°.

5. The fuse holder according to claim 2, wherein the fuse carrier has a motion screw thread as external thread, which engages with a motion screw thread as internal thread of the internal spaces.

6. The fuse holder according to claim 5, wherein the internal thread of the inner space of the first housing part together with the external thread of the first fuse carrier section of the fuse carrier engaging therewith and the internal thread of the inner space of the second housing part together with the external thread of the second fuse carrier section of the fuse carrier engaging therewith are formed in opposite directions to one another.

7. The fuse holder according to claim 1, wherein the fuse carrier has in its interior clip-shaped holding portions, which hold a fuse to be associated in a central region in the interior of the fuse carrier.

8. The fuse holder according to claim 1, wherein the fuse carrier has end sections at its ends, which each form a free space as an arc chamber in the open position of the fuse holder.

9. The fuse holder according to claim 1, wherein the fuse carrier has two radially opposite window cut-outs in its central region, the dimensions of the one window cut-out corresponding to a length and a diameter of a fuse to be accommodated in the fuse carrier.

10. The fuse holder according to any claim 1, wherein the housing parts are coupled to at least one guide rail arranged parallel to the longitudinal axis of the fuse holder.

11. The fuse holder according to claim 10, wherein the at least one guide rail is accommodated and guided in guide recesses corresponding to the shape of the at least one guide rail in each housing part movably in the direction of the longitudinal axis of the fuse holder.

12. The fuse holder according to claim 10, wherein the at least one guide rail limits a stop for an axial movement of the housing parts in the open position.

13. The fuse holder according to claim 1, wherein the fuse holder comprises connection terminals for electrical lines, the connection terminal being formed with a contact device for a fuse to be accommodated in the fuse carrier.

14. The fuse holder according to claim 13, wherein the contact device has a spring within the contact device which maintains a constant contact force against the fuse contacts, or/and that the contact device has circumferentially resilient lamellar contacts or lamellar springs which form an electrically conductive connection receptacle for a fuse contact of the fuse.

15. A fuse holder comprising at least two fuse holders according to claim 1, wherein the first housing parts of the at least two fuse holders consist of housing sections which are connected at their free ends by a joint.
